(19) United States
(12) Patent Application Publication
(10) Pub. No.: US 2025/0203667 A1
(43) Pub. Date: Jun. 19, 2025

(54) TECHNIQUES FOR DYNAMIC WAVEFORM SWITCHING DURING INITIAL ACCESS

(71) Applicant: Lenovo (United States) Inc., Morrisville, NC (US)

(72) Inventors: Ali Ramadan Ali, Kraiburg am Inn (DE); Karthikeyan Ganesan, Nauheim (DE)

(21) Appl. No.: 19/063,777

(22) Filed: Feb. 26, 2025

(51) Int. Cl. H04W 74/0833; H04W 72/0453

(52) U.S. Cl. CPC H04W 74/0833; H04W 72/0453

(57) ABSTRACT

Various aspects of the present disclosure relate to techniques for dynamic waveform switching during initial access. An apparatus is configured to transmit a first configuration via a default waveform to a user equipment (UE) during initial access, receive, from the UE, one or more indications of one or more requested waveforms during initial access where the one or more requested waveforms are different than the default waveform, and transmit a second configuration associated with the one or more requested waveforms during initial access.

### TECHNICAL FIELD

The present disclosure relates to wireless communications, and more specifically to techniques for dynamic waveform switching during initial access.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

An NE for wireless communication is described. The NE may be configured to, capable of, or operable to transmit a first configuration via a default waveform to a UE during initial access, wherein the first configuration comprises a mapping of synchronization signal blocks (SSBs) to random access channel (RACH) occasions (ROs), wherein each RO is associated with one or more of waveforms for downlink, uplink, or both; receive, from the UE, one or more indications of one or more requested waveforms during initial access, wherein the one or more requested waveforms are different than the default waveform; and transmit a second configuration associated with the one or more requested waveforms during initial access.

A processor for wireless communication is described. The processor may be configured to, capable of, or operable to transmit a first configuration via a default waveform to a UE during initial access, wherein the first configuration comprises a mapping of SSBs to ROs, wherein each RO is associated with one or more of waveforms for downlink, uplink, or both; receive, from the UE, one or more indications of one or more requested waveforms during initial access, wherein the one or more requested waveforms are different than the default waveform; and transmit a second configuration associated with the one or more requested waveforms during initial access.

A method for wireless communication performed by an NE is described. The method may be configured to, capable of, or operable to transmit a first configuration via a default waveform to a UE during initial access, wherein the first configuration comprises a mapping of SSBs to ROs, wherein each RO is associated with one or more of waveforms for downlink, uplink, or both; receive, from the UE, one or more indications of one or more requested waveforms during initial access, wherein the one or more requested waveforms are different than the default waveform; and transmit a second configuration associated with the one or more requested waveforms during initial access.

A UE for wireless communication is described. The UE may be configured to, capable of, or operable to receive a first configuration via a default waveform from a base station (BS) during initial access, wherein the first configuration comprises a mapping of SSBs to ROs, wherein each RO is associated with one or more of waveforms for downlink, uplink, or both; transmit, to the BS, one or more indications of one or more requested waveforms during initial access, wherein the one or more requested waveforms are different than the default waveform; and receive a second configuration associated with the one or more requested waveforms during initial access.

A processor for wireless communication is described. The processor may be configured to, capable of, or operable to receive a first configuration via a default waveform from a BS during initial access, wherein the first configuration comprises a mapping of SSBs to ROs, wherein each RO is associated with one or more of waveforms for downlink, uplink, or both; transmit, to the BS, one or more indications of one or more requested waveforms during initial access, wherein the one or more requested waveforms are different than the default waveform; and receive a second configuration associated with the one or more requested waveforms during initial access.

A method for wireless communication performed by a UE is described. The method may be configured to, capable of, or operable to receive a first configuration via a default waveform from a BS during initial access, wherein the first configuration comprises a mapping of SSBs to ROs, wherein each RO is associated with one or more of waveforms for downlink, uplink, or both; transmit, to the BS, one or more indications of one or more requested waveforms during initial access, wherein the one or more requested waveforms are different than the default waveform; and receive a second configuration associated with the one or more requested waveforms during initial access.

### BRIEF DESCRIPTION OF THE DRAWINGS

FIG. 1 illustrates an example of a wireless communications system, in accordance with aspects of the present disclosure.

FIG. 2 illustrates an example of an SSB to RO mapping, in accordance with aspects of the present disclosure.

FIG. 3 illustrates an example of an SSB to RO mapping, in accordance with aspects of the present disclosure.

FIG. 4 illustrates an example of an SSB to RO mapping, in accordance with aspects of the present disclosure.

FIG. 5 illustrates an example of the signaling between a BS and a UE for waveform switching during initial access, in accordance with aspects of the present disclosure.

FIG. 6 illustrates an example of a UE, in accordance with aspects of the present disclosure.

FIG. 7 illustrates an example of a processor, in accordance with aspects of the present disclosure.

FIG. 8 illustrates an example of an NE, in accordance with aspects of the present disclosure.

FIG. 9 illustrates a flowchart of a method performed by an NE, in accordance with aspects of the present disclosure.

FIG. 10 illustrates a flowchart of a method performed by a UE, in accordance with aspects of the present disclosure.

### DETAILED DESCRIPTION

Generally, the present disclosure describes systems, methods, and apparatuses for dynamically switching waveforms during initial access. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

A UE may be configured (e.g., equipped) with one or more transmitters and receivers that are configured to transmit and receive signals with different waveforms. For example, in 5G new radio (NR), Cyclic Prefix Orthogonal Frequency Multiplexing (CP-OFDM) waveforms may be used for downlink and uplink transmissions while Discrete Fourier Transform Spread OFDM (DFT-s-OFDM) waveforms may be used for uplink transmissions. Conventionally, depending on coverage and power consumption requirements, the uplink waveforms may be dynamically switched between CP-OFDM and DFT-s-OFDM while in a connected mode; however, during initial access, the waveform is semi-statically configured. As used herein, initial access may refer to a sequence of processes, signals, or the like, between a UE and a BS (e.g., gNB) for the UE to acquire uplink and/or downlink synchronization and obtain parameters for radio access communication.

In such case, during initial access, the BS does not have information about a UE's location within a cell, e.g., whether the UE is in a good proximity to the BS or whether the UE is at the cell edge. If located at the cell edge, there may be uplink coverage issues when the configured waveform is CP-OFDM. Furthermore, the BS, before the UE is connected, may not have information about the power consumption constraints of the UE (e.g., power status or power class of the UE), which is a factor to consider when selecting a suitable waveform. Thus, there is a need for a solution that provides for dynamically switching waveforms during initial access.

As described herein, by enabling the BS and the UE to dynamically switch waveforms during initial access, the BS and the UE may experience improved connection establishment between the BS and the UE, improved synchronization between the BS and the UE, improved efficiency during initial access, reduced latency, and optimized resource utilization. In this manner, battery life and operational efficiencies in UE and the BS devices can be enhanced.

Aspects of the present disclosure are described in the context of a wireless communications system. Note that one or more aspects from different solutions may be combined.

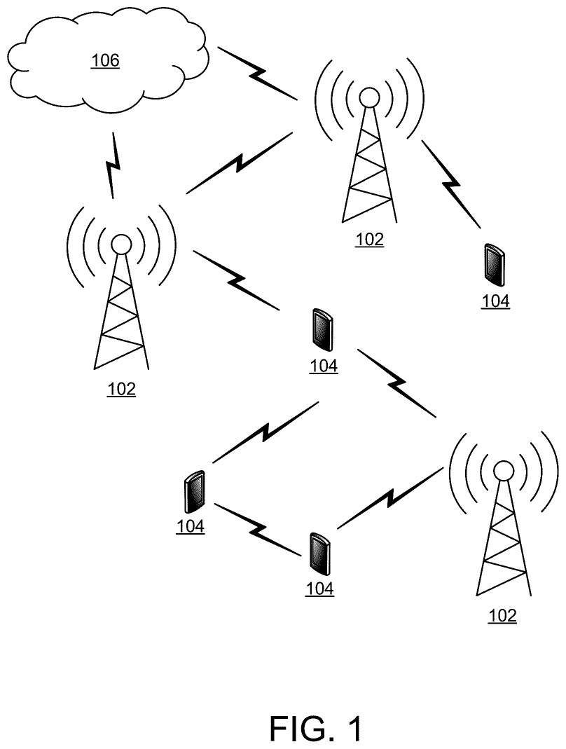

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For Type-1 random (initial) access procedure, a UE is provided a number N of synchronization signal (SS)/physical broadcast channel (PBCH) block indexes associated with one physical random access channel (PRACH) occasion and a number R of contention based preambles per SS/PBCH block index per valid PRACH occasion by ssb-perRACH-OccasionAndCB-PreamblesPerSSB.

For Type-2 random (initial) access procedure with common configuration of PRACH occasions with Type-1 random access procedure, a UE is provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB-PerSharedRO. The PRACH transmission can be on a subset of PRACH occasions associated with a same SS/PBCH block index within an SSB-RO mapping cycle for a UE provided with a PRACH mask index by msgA-SSB-SharedRO-MaskIndex, e.g., according to TS 38.321, incorporated herein by reference.

For Type-2 random access procedure with separate configuration of PRACH occasions with Type-1 random access procedure, a UE is provided a number N of SS/PBCH block indexes associated with one PRACH occasion and a number R of contention based preambles per SS/PBCH block index per valid PRACH occasion by msgA-SSB-PerRACH-OccasionAndCB-PreamblesPerSSB when provided; otherwise, by ssb-perRACH-OccasionAndCB-PreamblesPerSSB.

For a random access procedure associated with a feature combination indicated by FeatureCombinationPreambles, a UE is provided a number N of SS/PBCH block indexes associated with one PRACH occasion by ssb-perRACH-OccasionAndCB-PreamblesPerSSB or msgA-SSB-PerRACH-OccasionAndCB-PreamblesPerSSB when provided and a number S of contention based preambles per SS/PBCH block index per valid PRACH occasion by startPreambleForThisPartition and numberOfPreamblesPerSSB-ForThisPartition. The PRACH transmission can be on a subset of PRACH occasions associated with a same SS/PBCH block index within an SSB-RO mapping cycle for a UE provided with a PRACH mask index by ssb-SharedRO-MaskIndex according to TS 38.321.

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·N_{preamble}^{total}/N where N_{preamble}^{total} is provided by totalNumberOfRA-Preambles for Type-1 random access procedure, or by msgA-TotalNumberOfRA-Preambles for Type-2 random access procedure with separate configuration of PRACH occasions from a Type 1 random access procedure, and is an integer multiple of N.

For Type-2 random access procedure with common configuration of PRACH occasions with Type-1 random access procedure, if N<1, one SS/PBCH block index is mapped to 1/N consecutive valid PRACH occasions and Q contention based preambles with consecutive indexes associated with the SS/PBCH block index per valid PRACH occasion start from preamble index R. If N≥1, Q contention based preambles with consecutive indexes associated with SS/PBCH block index n, 0≤n≤N−1, per valid PRACH occasion start from preamble index n·N_{preamble}^{total}/N+R, where N_{preamble}^{total} is provided by totalNumberOfRA-Preambles for Type-1 random access procedure.

SS/PBCH block indexes provided by ssb-PositionsInBurst in system information block 1 (SIB1) or in ServingCellConfigCommon or in SSB-MTC-AdditionalPCI or in LTM-SSB-Config are mapped to valid PRACH occasions in the following order, e.g., where the parameters are described in TS 38.211 (incorporated herein by reference).

First, in increasing order of preamble indexes within a single PRACH occasion. Second, in increasing order of frequency resource indexes for frequency multiplexed PRACH occasions. Third, in increasing order of time resource indexes for time multiplexed PRACH occasions within a PRACH slot. Fourth, in increasing order of indexes for PRACH slots.

An association period, starting from frame 0, for mapping SS/PBCH block indexes to PRACH occasions is the smallest integer number in the set determined by the PRACH configuration period such that N_{TX}^{SSB} SS/PBCH block indexes are mapped at least once to the PRACH occasions within the association period, where a UE obtains N_{TX}^{SSB} from the value of ssb-PositionsInBurst in SIB1 or in ServingCellConfigCommon or in SSB-MTC-AdditionalPCI or in LTM-SSB-Config. If after an integer number of SS/PBCH block indexes to PRACH occasions mapping cycles within the association period there is a set of PRACH occasions or PRACH preambles that are not mapped to N_{TX}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

For a PRACH transmission by a UE triggered by a physical downlink control channel (PDCCH) order or an lower layer triggered mobility (LTM) cell switch command medium access control (MAC) control element (CE), the PRACH mask index field, if the value of the random access preamble index field is not zero, indicates the PRACH occasion for the PRACH transmission where the PRACH occasions are associated with the SS/PBCH block index indicated by the SS/PBCH block index field of the PDCCH order or the LTM cell switch command MAC CE and, if any, a cell indicator field in PDCCH order, e.g., described in TS 38.212 (incorporated herein by reference) or a Target Configuration ID field in LTM cell switch command MAC CE, e.g., as described in TS 38.321 (incorporated herein by reference) indicates a cell for the PRACH transmission. If the UE is provided K_{cell,offset} by cellSpecifickoffset, the PRACH occasion is after slot n+2^{μ}·K_{cell,offset} where n is the slot of the uplink bandwidth part (BWP) for the PRACH transmission that overlaps with the end of the PDCCH order reception assuming T_{TA}=0, and μ is the SCS configuration for the PRACH transmission. If the PDCCH reception for the PDCCH order includes two PDCCH candidates from two linked search space sets based on searchSpaceLinkingId the last symbol of the PDCCH reception is the last symbol of the PDCCH candidate that ends later. The PDCCH reception includes the two PDCCH candidates also when the UE is not required to monitor one of the two PDCCH candidates.

For a PRACH transmission triggered by higher layers, if ssb-ResourceList is provided, the PRACH mask index is indicated by ra-ssb-OccasionMaskIndex which indicates the PRACH occasions for the PRACH transmission where the PRACH occasions are associated with the selected SS/PBCH block index.

The PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For the indicated preamble index, the ordering of the PRACH occasions is, first, in increasing order of frequency resource indexes for frequency multiplexed PRACH occasions; second, in increasing order of time resource indexes for time multiplexed PRACH occasions within a PRACH slot; and, third, in increasing order of indexes for PRACH slots.

For a PRACH transmission triggered upon request by higher layers, a value of ra-OccasionList, e.g., as described in TS 38.331 (incorporated herein by reference), if csirs-ResourceList is provided, indicates a list of PRACH occasions for the PRACH transmission where the PRACH occasions are associated with the selected CSI-RS index indicated by csi-RS. The indexing of the PRACH occasions indicated by ra-OccasionList is reset per association pattern period.

For paired spectrum or supplementary uplink band all PRACH occasions are valid. For unpaired spectrum, if a UE is not provided tdd-UL-DL-ConfigurationCommon for a cell, a PRACH occasion for the cell in a PRACH slot is valid if it does not precede a SS/PBCH block in the PRACH slot and starts at least N_{gap} symbols after a last SS/PBCH block reception symbol, where N_{gap} and, if channelAccessMode=“semiStatic” is provided, does not overlap with a set of consecutive symbols before the start of a next channel occupancy time where the UE does not transmit, e.g., as described in TS 37.213 (incorporated herein by reference). The candidate SS/PBCH block index of the SS/PBCH block corresponds to the SS/PBCH block index provided by ssb-PositionsInBurst in SIB1 or in ServingCellConfigCommon or in SSB-MTC-AdditionalPCI corresponding to the cell.

For each of the candidate cells configured by LTM-Config, if a UE is not provided ltm-TDD-UL-DL-ConfigurationCommon, a PRACH occasion in a PRACH slot is valid if it does not precede a SS/PBCH block in the PRACH slot and starts at least N_{gap} symbols after a last SS/PBCH block reception symbol. the SS/PBCH block index of the SS/PBCH block corresponds to the SS/PBCH block index provided by ssb-PositionsInBurst in LTM-SSB-Config for each of the candidate cells.

If a UE is provided tdd-UL-DL-ConfigurationCommon for a cell, a PRACH occasion for the cell in a PRACH slot is valid if it is within uplink symbols, or it does not precede a SS/PBCH block in the PRACH slot and starts at least N_{gap} symbols after a last downlink symbol and at least N_{gap} symbols after a last SS/PBCH block symbol, and if channel AccessMode=“semiStatic” is provided, does not overlap with a set of consecutive symbols before the start of a next channel occupancy time where there shall not be any transmissions, as described in TS 37.213. The candidate SS/PBCH block index of the SS/PBCH block corresponds to the SS/PBCH block index provided by ssb-PositionsInBurst in SIB1 or in ServingCellConfigCommon or in SSB-MTC-AdditionalPCI corresponding to the cell.

for each of the candidate cells configured by LTM-config, if a UE is provided ltm-tdd-UL-DL-ConfigurationCommon, a PRACH occasion in a PRACH slot is valid if it is within uplink symbols, or it does not precede a SS/PBCH block in the PRACH slot and starts at least N_{gap} symbols after a last downlink symbol and at least N_{gap} symbols after a last SS/PBCH block symbol. The SS/PBCH block index of the SS/PBCH block corresponds to the SS/PBCH block index provided by ssb-PositionsInBurst in LTM-SSB-Config for each of the candidate cells.

For a physical uplink shared channel (PUSCH) scheduled by random access response (RAR) uplink grant, or for a PUSCH scheduled by fallbackRAR uplink grant, or for a PUSCH scheduled by downlink control information (DCI) format 0_0 with cyclic redundancy check (CRC) scrambled by temporary cell radio network temporary identifier (TC-RNTI), the UE shall consider the transform precoding either ‘enabled’ or ‘disabled’ according to the higher layer configured parameter msg3-transformPrecoder.

For a MsgA PUSCH, the UE shall consider the transform precoding either ‘enabled’ or ‘disabled’ according to the higher layer configured parameter msgA-TransformPrecoder. If higher layer parameter msgA-TransformPrecoder is not configured, the UE shall consider the transform precoding either ‘enabled’ or ‘disabled’ according to the higher layer configured parameter msg3-transformPrecoder.

For PUSCH transmission scheduled by a PDCCH with CRC scrambled by configured scheduling (CS)-RNTI with NDI=1, C-RNTI, or modulation and coding scheme (MCS)-C-RNTI or semi-persistent (SP)-channel state information (CSI)-RNTI:

If the DCI with the scheduling grant was received with DCI format 0_0, the UE shall, for this PUSCH transmission, consider the transform precoding either enabled or disabled according to the higher layer configured parameter msg3-transformPrecoder from rach-ConfigCommon included directly within BWP configuration;

If the DCI with the scheduling grant was not received with DCI format 0_0;

If the DCI with the scheduling grant was received with DCI format 0 1 or 0 2 with CRC scrambled by C-RNTI, MCS-RNTI, or CS-RNTI with NDI=1 and if the UE is configured with a higher layer parameter dynamicTransformPrecoderFieldPresenceDCI-0-1 in pusch-Config for DCI format 0_1 or dynamicTransformPrecoderFieldPresenceDCI-0-2 in pusch-Config for DCI format 0_2 and the higher layer parameter is set to ‘enabled’. The UE shall, for this PUSCH transmission, consider the transform precoding either enabled or disabled according to the Transform precoder indicator field in the DCI with the scheduling grant.

For pusch-TimeDomainAllocationListForMultiPUSCH in pusch-Config, the UE shall, for all PUSCH transmissions, consider the transform precoding either enabled or disabled according to Transform precoder indicator field in the DCI format 0_1 with the scheduling grant.

If resourceAllocation in pusch-Config for DCI format 0_1 or resourceAllocationDCI-0-2 in pusch-Config for DCI format 0_2 is set to resourceAllocationType0, or if the resource allocation is set to resource allocation type 0according to the DCI configuration, e.g., as described in clauses 7.3.1.1.2 and 7.3.1.1.3 of TS 38.212, or if dmrs-Type in DMRS-UplinkConfig is set to ‘type 2’ for this PUSCH transmission, the UE does not expect that the Transform precoder indicator field in the DCI with the scheduling grant indicates that transform precoding is enabled.

If the UE is configured with the higher layer parameter dmrs-TypeEnh in DMRS-UplinkConfig, and if the scheduling grant indicates that transform precoding is enabled for the scheduled PUSCH transmission, the UE ignores the higher layer parameters dmrs-TypeEnh in DMRS-UplinkConfig, if configured, for the demodulation reference signal (DM-RS) transmission of the scheduled PUSCH transmission.

Otherwise, if the UE is configured with the higher layer parameter transformPrecoder in pusch-Config, the UE shall, for this PUSCH transmission, consider the transform precoding either enabled or disabled according to this parameter. If the UE is not configured with the higher layer parameter transformPrecoder in pusch-Config, the UE shall, for this PUSCH transmission, consider the transform precoding either enabled or disabled according to the higher layer configured parameter msg3-transformPrecoder.

For PUSCH transmission with a configured grant, if the UE is configured with the higher layer parameter transformPrecoder in configuredGrantConfig, the UE shall, for this PUSCH transmission, consider the transform precoding either enabled or disabled according to this parameter. If the UE is not configured with the higher layer parameter transformPrecoder in configuredGrantConfig, the UE shall, for this PUSCH transmission, consider the transform precoding either enabled or disabled according to the higher layer configured parameter msg3-transformPrecoder.

In a first embodiment of the disclosed solution, the BS configures the UE (e.g., via SIB1) with a mapping of SSBs to ROs and instruction for using a suitable RO for transmitting PRACH. The mapping may be created based on multiple potential waveforms that are available to communicate between the UE and the BS after receiving the SSB. The BS and the UE may communicate with a default waveform until the configuration and waveform selection is completed.

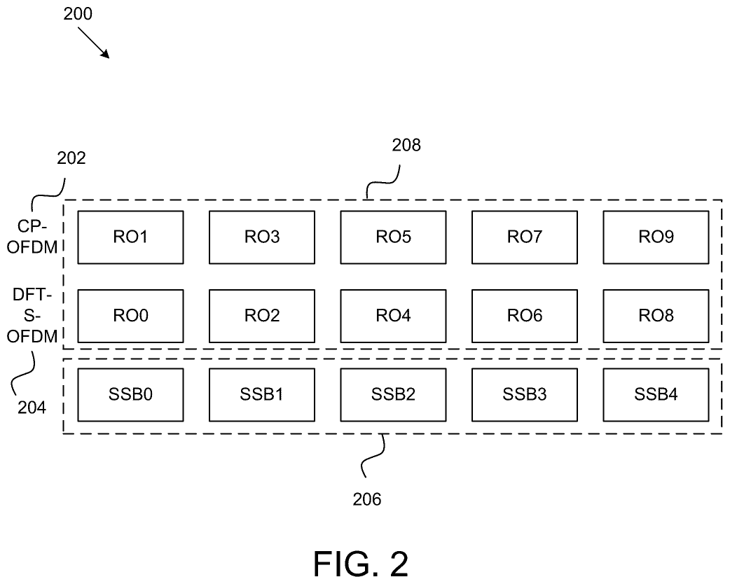

FIG. 2 illustrates an example of an SSB to RO mapping, in accordance with aspects of the present disclosure. In one implementation, the mapping 200 is associated with an uplink waveform 202, 204. In one embodiment, the UE assists in selecting the best waveform 202, 204 for uplink communications. In such an embodiment, each SSB 206 is mapped to multiple ROs 208, wherein each RO 208 is associated with a waveform 202, 204 to be used for uplink (e.g., CP-OFDM, DFT-s-OFDM, etc.).

In one embodiment, upon receiving SSBs 206, the UE measures the quality of the SSBs 206 to identify the best detected SSB 206 e.g., based on a reference signal received power (RSRP) of PBCH DMRS and according to the instructions provided in SIB1. In one example, the selection criteria can depend on a predefined threshold for an RSRP of an SSB 206, the power status or power class of the UE, or combination thereof.

In one embodiment, the UE transmits PRACH using a default waveform 202, 204 (e.g., the waveform used to receive the SSB 206) on the associated RO 208 associated with the uplink waveform. For example, CP-OFDM 202 may be selected based on the RSRP of the SSB 206 (e.g., high RSRP) and/or the power consumption constraints at the UE, e.g., whether the UE has enough power (e.g., no power consumption constraints). In another example, DFT-s-OFDM 204 may be selected in the event of low RSRP and/or if the UE has power consumption constraints or requirements.

In one embodiment, the BS, based on which RO PRACH is received, transmits a RAR message using the default waveform (e.g., the waveform used for transmitting the SSB 206) with waveform configuration for message 3 (Msg3) and the uplink channels. As used herein, Msg3 may refer to a first scheduled PUSCH transmission with the RAR uplink grant that allows UEs to initiate communication with the network and request the necessary resources for uplink transmission during the initial (random) access procedure.

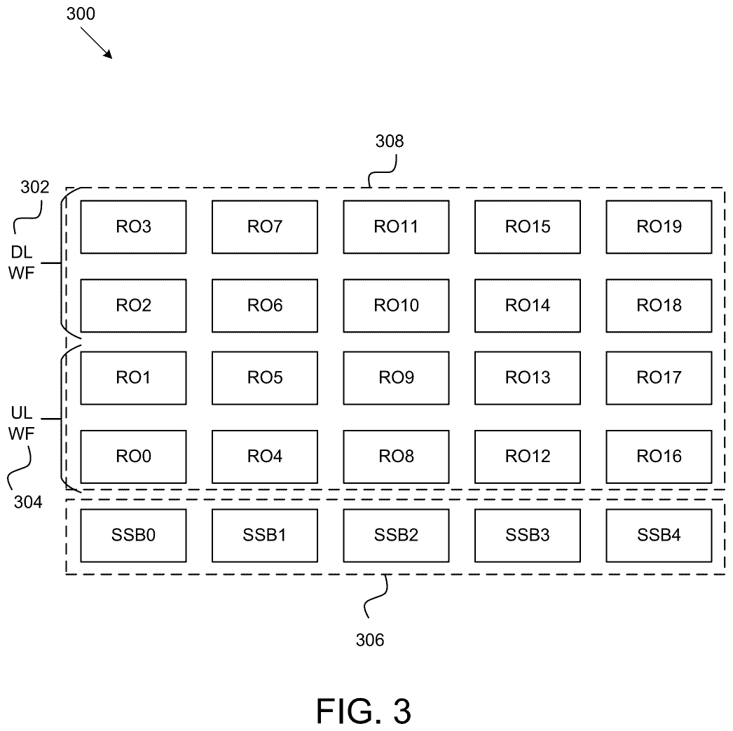

FIG. 3 illustrates an example of an SSB to RO mapping, in accordance with aspects of the present disclosure. In one implementation, the BS configures the UE via SIB1 using an RRC message with the mapping 300 of SSBs 306 to ROs 308 according to the associated uplink 304 and downlink 302 waveforms. In one embodiment, each SSB 306 is mapped to multiple ROs 308. In certain embodiments, some ROs 308 are associated with uplink waveforms 304, some ROs 308 are associated with downlink waveforms 302, or a combination thereof.

In one embodiment, the UE measures the SSB 306 and identifies the best SSB 306 index. Based on the quality of the SSB 306, according to a predefined threshold, based on the power status and/or power class of the UE, the UE transmits a PRACH using the default waveform on the associated RO 308 for its associated waveform for uplink 304 and transmits another PRACH with the same preamble on the associated RO 308 for its associated waveform for downlink 302.

In one embodiment, the BS, based on which RO PRACH is received, transmits a RAR message using a default waveform with an uplink waveform 304 configuration for Msg3 and other uplink channels and/or signals, and a configuration for a downlink waveform 302 for message 4 (Msg4) and other downlink channels and/or signals. As used herein, Msg4 may refer to a contention resolution transmission that contains information indicating whether the initial (random) access procedure is successful.

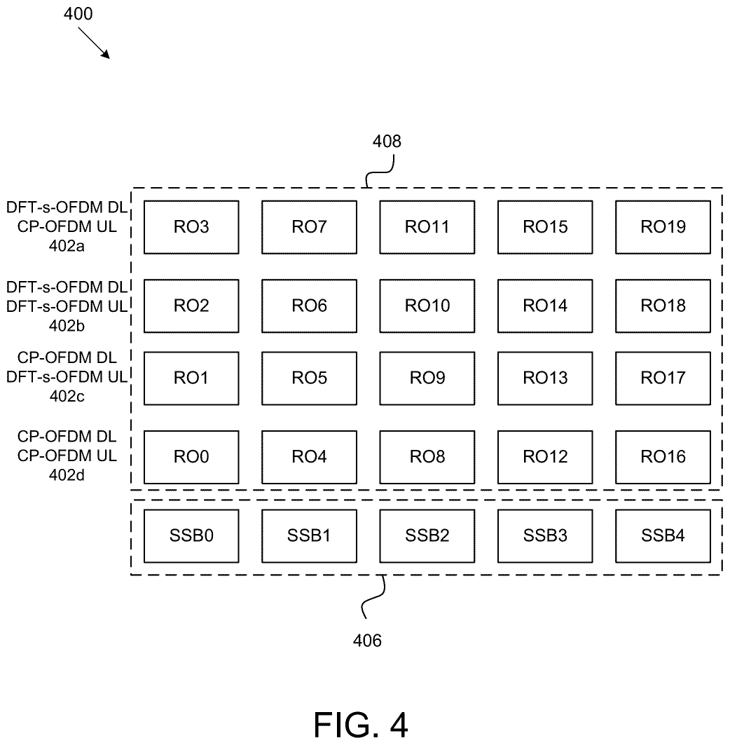

FIG. 4 illustrates an example of an SSB to RO mapping, in accordance with aspects of the present disclosure. In one implementation, the mapping 400 of the SSBs 406 to ROs 408 instructs the UE to transmit a single PRACH on one RO 408. In such an embodiment, the RO 408 is associated with an indication for both downlink and uplink waveforms 402a-402d.

According to a second embodiment, the BS configures the UE (e.g., via SIB1) with the mapping of SSBs to ROs and instructions for using an RO that is suitable for transmitting PRACH. The mapping may be created or generated based on multiple potential waveforms that are available for communications between the UE and BS after receiving the SSB. In one embodiment, the BS and the UE communicate with a waveform that the UE requests in response to measuring the SSB.

In one implementation, the mapping is associated with an uplink waveform that is selected based on assistance from the UE. In one embodiment, each SSB is mapped to multiple ROs. In such an embodiment, each RO is associated with a waveform to be used for uplink (e.g., CP-OFDM, DFT-s-OFDM, or the like), as shown in FIG. 2.

In one embodiment, in response to receiving the SSB, the UE measures the quality of the best detected SSB (e.g., the RSRP of PBCH DMRS) based on the quality of SSB and according to instructions provided in SIB1. In one example, the selection criteria may depend on a predefined threshold for the RSRP of the SSB for the UE, the power status or power class of the UE, or a combination thereof.

In one embodiment, the UE transmits PRACH using the selected or requested waveform on the associated RO for its associated uplink waveform. For example, CP-OFDM may be selected if there is sufficient RSRP of the SSB and/or if the UE has enough power (e.g., there are no power consumption constraints), and DFT-s-OFDM may be selected in if there is low or not sufficient RSRP of the SSB and/or if the UE has power consumption constraints.

In one embodiment, the BS, based on which RO is used to receive the PRACH, and on which waveform PRACH was transmitted (the BS may try multiple waveforms to detect PRACH), in one example, transmits a RAR that includes a waveform configuration for Msg3 using the requested waveform. In another example, the BS transmits a RAR using the requested waveform, if the BS approves the requested waveform, or using the default waveform if the BS does not approve the requested waveform. In one embodiment, the UE may detect a RAR with the requested waveform, and, if it is not decoded, the UE assumes that the BS rejected waveform switching and attempts to receive RAR messages using the default waveform.

In one embodiment, the BS configures the UE in SIB1 using an RRC message with the SSB to ROs mapping according to the associated uplink and downlink waveforms. In one embodiment, each SSB may be mapped to multiple ROs where some ROs are associated with uplink waveforms and other ROs are associated with downlink waveforms, as shown in FIG. 2.

In one embodiment, the UE measures the SSB and identifies the best SSB index. Based on the quality of the SSB, according to a predefined threshold, based on the power status and/or power class of the UE, the UE transmits a PRACH using the requested waveform on the associated RO for its associated waveform for uplink and transmits another PRACH with the same preamble on the associated RO for its associated waveform for downlink.

In one embodiment, the BS, based on which RO PRACH is received, transmits a RAR message using the requested waveform for downlink that includes an uplink waveform configuration for Msg3 and other uplink channels and/or signals, and a configuration for a downlink waveform for Msg4 and other downlink channels and/or signals. In another example, the BS transmits a RAR with the requested downlink waveform if the BS approves the downlink waveform or the BS transmits the RAR with the default waveform if the BS does not approve the requested DL waveform.

In one embodiment, the mapping of SSBs to ROs instructs the UE to transmit a single PRACH using the requested uplink waveform on one RO. In such an embodiment, the RO is associated with an indication for both downlink and uplink waveforms, as shown in FIG. 4.

In one embodiment, the BS transmits a waveform configuration to the UE in a RAR message. In such an embodiment, the configuration indicates to the UE to use one or more waveforms for uplink, downlink, or both. The configuration may depend on one or more characteristics of PRACH. For example, the quality of PRACH, the timing advance measured on PRACH preamble, or the like.

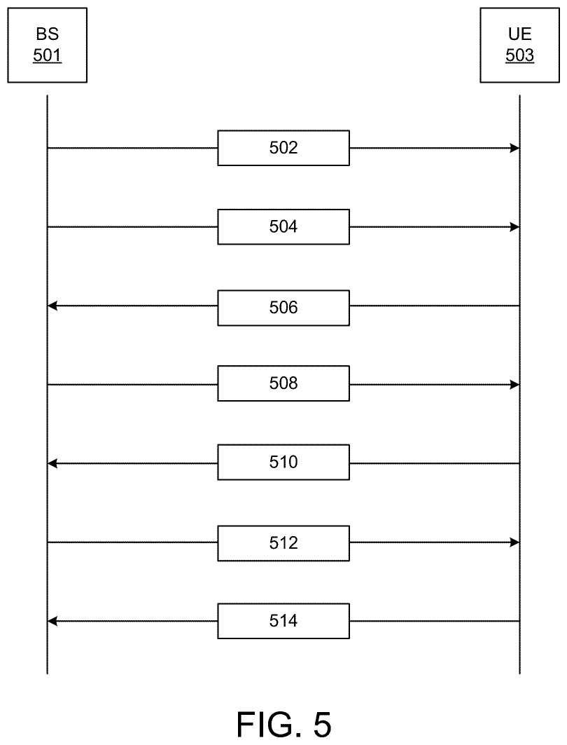

FIG. 5 illustrates an example of the signaling between a BS and a UE for waveform switching during initial access, in accordance with aspects of the present disclosure. In one embodiment, at steps 502 and 504, the BS 501 transmits a configuration (e.g., in an SSB and/or a SIB1) that includes the mapping of the SSBs to the ROs. In one embodiment, the configuration may also include the number of ROs for each SSB, the location of ROs in correspondence with the SSBs (e.g., frequency-division multiplexed and/or time-division multiplexed), an indication of whether the ROs are associated with uplink waveforms, downlink waveforms, or both, and an indication of whether the communication is performed with the default waveform or with a requested waveform.

In response to receiving the SSB and/or SIB1, in one embodiment, the UE 503 measures the SSB and determines the suitable waveform based on the SIB configuration. In one embodiment, at step 506, the UE 503 transmits a PRACH in one or more ROs that are associated with the requested waveform. The UE 503 may transmit the PRACH using the default waveform or using the requested waveform, based on the SIB1 configuration.

In one embodiment, in response to receiving the PRACH, the BS 501 transmits, at step 508, a RAR that contains the configuration related to the requested waveform for Msg3. In such an embodiment, the BS may transmit the RAR using the default waveform or using the requested waveform, based on the SIB1 configuration.

In one embodiment, at step 510, the UE transmits the Msg3 using the waveform that is configured by the RAR. In one embodiment, at step 512, the BS transmits Msg4 using the waveform that is configured by the RAR. In certain embodiments, at step 514, the UE 503 transmits an acknowledgement of Msg4.

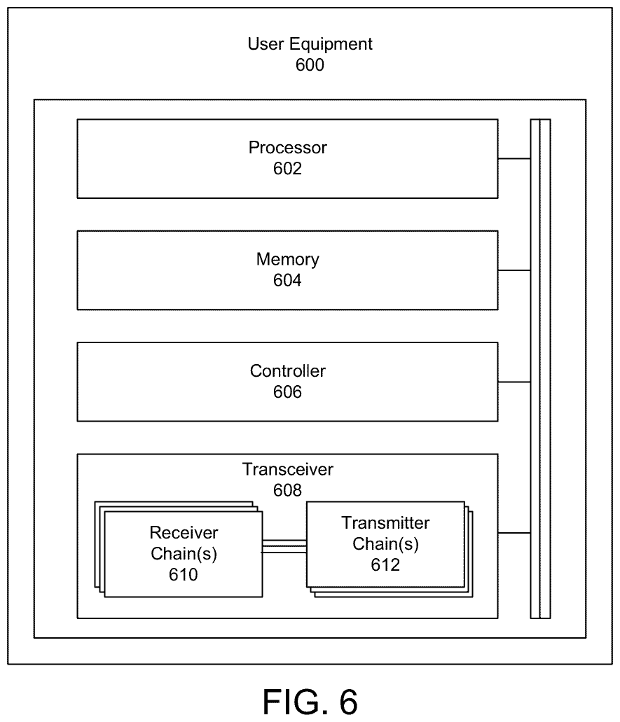

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field programmable gate array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions that, when executed by the processor 602, cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the UE functions described herein (e.g., executing, by the processor 602, instructions stored in the memory 604). Accordingly, the processor 602 may support wireless communication at the UE 600 in accordance with examples as disclosed herein.

In one embodiment, the UE 600 is configured to receive a first configuration via a default waveform from a BS during initial access, wherein the first configuration comprises a mapping of SSBs to ROs, wherein each RO is associated with one or more of waveforms for downlink, uplink, or both. In one embodiment, the UE 600 is configured to transmit, to the BS, one or more indications of one or more requested waveforms during initial access, wherein the one or more requested waveforms are different than the default waveform. In one embodiment, the UE 600 is configured to receive a second configuration associated with the one or more requested waveforms during initial access.

In one embodiment, the UE 600 is configured to receive a system information block one (SIB1), wherein the first configuration is transmitted via the SIB1. In one embodiment, the UE 600 is configured to transmit one or more first random access transmissions to the BS during one or more ROs associated with one or more SSBs, wherein the one or more first random access transmissions is associated with the default waveform, and wherein the one or more indications of one more requested waveforms is received via the one or more first random access transmissions. In one embodiment, the UE 600 is configured to receive one or more second random access transmissions from the BS based at least in part on the received one or more first random access transmissions, and wherein the second configuration is transmitted via the one or more second random access transmissions.

In one embodiment, the UE 600 is configured to transmit a first PRACH transmission to the BS during at least one RO, wherein the first PRACH transmission is indicative of at least one waveform for uplink, and transmit a second PRACH transmission to the BS during at least one RO, wherein the second PRACH transmission is indicative of at least one waveform for downlink.

The controller 606 may manage input and output signals for the UE 600. The controller 606 may also manage peripherals not integrated into the UE 600. In some implementations, the controller 606 may utilize an operating system (OS) such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding/processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

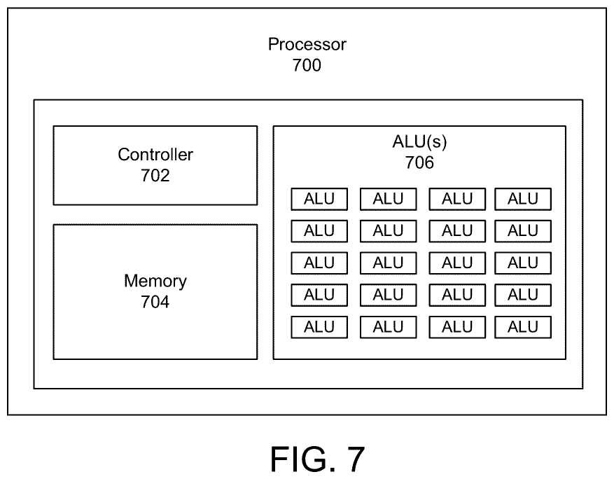

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

In various embodiments, the processor 700 may support wireless communication of a UE, in accordance with examples as disclosed herein. In other embodiments, the processor 700 may support wireless communication of a RAN entity, in accordance with examples as disclosed herein.

In one embodiment, the processor 700 is configured to transmit a first configuration via a default waveform to a UE during initial access, wherein the first configuration comprises a mapping of SSBs to ROs, wherein each RO is associated with one or more of waveforms for downlink, uplink, or both. In one embodiment, the processor 700 is configured to receive, from the UE, one or more indications of one or more requested waveforms during initial access, wherein the one or more requested waveforms are different than the default waveform. In one embodiment, the processor 700 is configured to transmit a second configuration associated with the one or more requested waveforms during initial access.

In one embodiment, the processor 700 is configured to transmit a system information block one (SIB1), wherein the first configuration is transmitted via the SIB1. In one embodiment, the processor 700 is configured to receive one or more first random access transmissions from the UE during one or more ROs associated with one or more SSBs, wherein the one or more first random access transmissions is associated with the default waveform, and wherein the one or more indications of one more requested waveforms is received via the one or more first random access transmissions. In one embodiment, the processor 700 is configured to transmit one or more second random access transmissions to the UE based at least in part on the received one or more first random access transmissions, and wherein the second configuration is transmitted via the one or more second random access transmissions.

In one embodiment, the processor 700 is configured to receive a first PRACH) transmission from the UE during at least one RO, wherein the first PRACH transmission is indicative of at least one waveform for uplink, and receive a second PRACH transmission from the UE during at least one RO, wherein the second PRACH transmission is indicative of at least one waveform for downlink.

In one embodiment, one or more of the first PRACH transmission and the second PRACH transmission are received via the default waveform or at least one waveform of the one or more requested waveforms. In one embodiment, one or more of the first PRACH transmission and the second PRACH transmission are received during a same RO or different ROs.

In one embodiment, the second configuration comprises information for each of the at least one waveform for uplink and the at least one waveform for downlink for one or more subsequent random access transmissions associated with the initial access. In one embodiment, the one or more second random access transmissions are transmitted via the default waveform in response to a rejection of the one or more requested waveforms by the processor 700 for initial access and the one or more second random access transmissions are transmitted via the one or more requested waveforms in response to an acceptance of the one or more requested waveforms by the NE for initial access.

In one embodiment, the processor 700 is configured to receive a random access transmission during initial access and based at least in part on the second configuration, wherein the random access transmission comprises a random access Msg3, and wherein the random access transmission is associated with at least one waveform for uplink associated with the one or more requested waveforms. In one embodiment, the processor 700 is configured to transmit a random access transmission during initial access and based at least in part on the second configuration, wherein the random access transmission comprises a random access Msg4, and wherein the random access transmission is associated with at least one waveform for downlink associated with the one or more requested waveforms.

In one embodiment, each SSB is associated with multiple ROs, and wherein each RO of the multiple ROs is associated with one or more of a respective downlink waveform or a respective uplink waveform. In one embodiment, each of one or more of the default waveform, the downlink waveform, or the uplink waveform comprises a CP-OFDM waveform or a DFT-s-OFDM waveform. In one embodiment, the one or more indications is implicitly received based on one or more selected ROs associated with the one or more requested waveforms.

In one embodiment, the processor 700 is configured to receive a first configuration via a default waveform from a BS during initial access, wherein the first configuration comprises a mapping of SSBs to ROs, wherein each RO is associated with one or more of waveforms for downlink, uplink, or both. In one embodiment, the processor 700 is configured to transmit, to the BS, one or more indications of one or more requested waveforms during initial access, wherein the one or more requested waveforms are different than the default waveform. In one embodiment, the processor 700 is configured to receive a second configuration associated with the one or more requested waveforms during initial access.

In one embodiment, the processor 700 is configured to receive a SIB1, wherein the first configuration is transmitted via the SIB1. In one embodiment, the processor 700 is configured to transmit one or more first random access transmissions to the BS during one or more ROs associated with one or more SSBs, wherein the one or more first random access transmissions is associated with the default waveform, and wherein the one or more indications of one more requested waveforms is received via the one or more first random access transmissions. In one embodiment, the processor 700 is configured to receive one or more second random access transmissions from the BS based at least in part on the received one or more first random access transmissions, and wherein the second configuration is transmitted via the one or more second random access transmissions.

In one embodiment, the processor 700 is configured to transmit a first PRACH transmission to the BS during at least one RO, wherein the first PRACH transmission is indicative of at least one waveform for uplink, and transmit a second PRACH transmission to the BS during at least one RO, wherein the second PRACH transmission is indicative of at least one waveform for downlink.

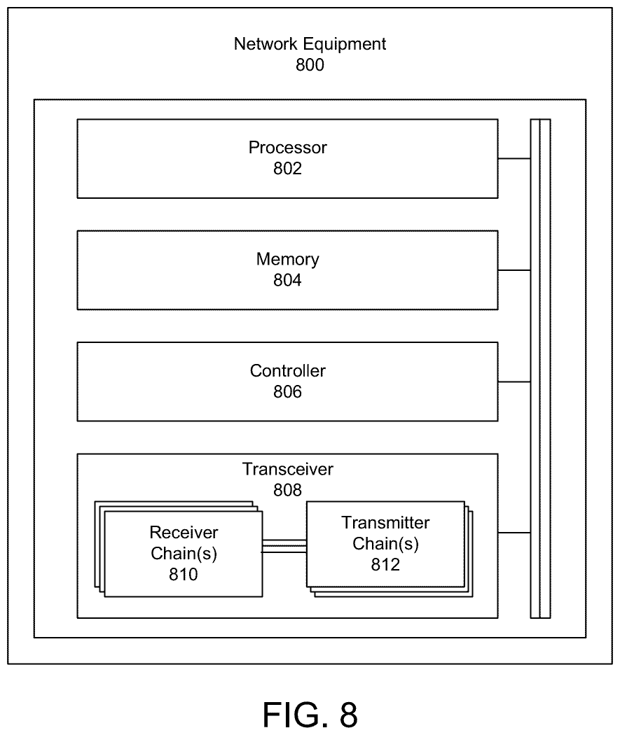

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the RAN functions described herein (e.g., executing, by the processor 802, instructions stored in the memory 804). For example, the processor 802 may support wireless communication at the NE 800 in accordance with examples as disclosed herein.

In one embodiment, the NE 800 is configured to transmit a first configuration via a default waveform to a UE during initial access, wherein the first configuration comprises a mapping of SSBs to ROs, wherein each RO is associated with one or more of waveforms for downlink, uplink, or both. In one embodiment, the NE 800 is configured to receive, from the UE, one or more indications of one or more requested waveforms during initial access, wherein the one or more requested waveforms are different than the default waveform. In one embodiment, the NE 800 is configured to transmit a second configuration associated with the one or more requested waveforms during initial access.

In one embodiment, the NE 800 is configured to transmit a SIB1, wherein the first configuration is transmitted via the SIB1. In one embodiment, the NE 800 is configured to receive one or more first random access transmissions from the UE during one or more ROs associated with one or more SSBs, wherein the one or more first random access transmissions is associated with the default waveform, and wherein the one or more indications of one more requested waveforms is received via the one or more first random access transmissions. In one embodiment, the NE 800 is configured to transmit one or more second random access transmissions to the UE based at least in part on the received one or more first random access transmissions, and wherein the second configuration is transmitted via the one or more second random access transmissions.

In one embodiment, the NE 800 is configured to receive a first PRACH) transmission from the UE during at least one RO, wherein the first PRACH transmission is indicative of at least one waveform for uplink, and receive a second PRACH transmission from the UE during at least one RO, wherein the second PRACH transmission is indicative of at least one waveform for downlink.

In one embodiment, one or more of the first PRACH transmission and the second PRACH transmission are received via the default waveform or at least one waveform of the one or more requested waveforms. In one embodiment, one or more of the first PRACH transmission and the second PRACH transmission are received during a same RO or different ROs.

In one embodiment, the second configuration comprises information for each of the at least one waveform for uplink and the at least one waveform for downlink for one or more subsequent random access transmissions associated with the initial access. In one embodiment, the one or more second random access transmissions are transmitted via the default waveform in response to a rejection of the one or more requested waveforms by the NE for initial access and the one or more second random access transmissions are transmitted via the one or more requested waveforms in response to an acceptance of the one or more requested waveforms by the NE for initial access.

In one embodiment, the NE 800 is configured to receive a random access transmission during initial access and based at least in part on the second configuration, wherein the random access transmission comprises a random access Msg3, and wherein the random access transmission is associated with at least one waveform for uplink associated with the one or more requested waveforms. In one embodiment, the NE 800 is configured to transmit a random access transmission during initial access and based at least in part on the second configuration, wherein the random access transmission comprises a random access Msg4, and wherein the random access transmission is associated with at least one waveform for downlink associated with the one or more requested waveforms.

In one embodiment, each SSB is associated with multiple ROs, and wherein each RO of the multiple ROs is associated with one or more of a respective downlink waveform or a respective uplink waveform. In one embodiment, each of one or more of the default waveform, the downlink waveform, or the uplink waveform comprises a CP-OFDM waveform or a DFT-s-OFDM waveform. In one embodiment, the one or more indications is implicitly received based on one or more selected ROs associated with the one or more requested waveforms.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

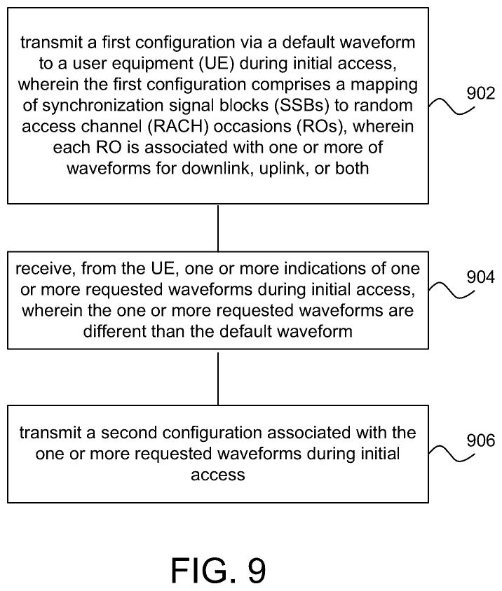

FIG. 9 illustrates a flowchart of a method performed by an NE 800 in accordance with aspects of the present disclosure. The operations of the method may be implemented by a NE 800 as described herein. In some implementations, the NE 800 may execute a set of instructions to control the function elements of the NE 800 to perform the described functions.

At step 902, the method may transmit a first configuration via a default waveform to a UE during initial access, wherein the first configuration comprises a mapping of SSBs to ROs, wherein each RO is associated with one or more of waveforms for downlink, uplink, or both. The operations of step 902 may be performed in accordance with examples as described herein. In some implementations, aspects of the operations of step 902 may be performed by a NE 800, as described with reference to FIG. 8.

At step 904, the method may receive, from the UE, one or more indications of one or more requested waveforms during initial access, wherein the one or more requested waveforms are different than the default waveform. The operations of step 904 may be performed in accordance with examples as described herein. In some implementations, aspects of the operations of step 904 may be performed by an NE 800, as described with reference to FIG. 8.

At step 906, the method may transmit a second configuration associated with the one or more requested waveforms during initial access. The operations of step 906 may be performed in accordance with examples as described herein. In some implementations, aspects of the operations of step 906 may be performed by an NE 800, as described with reference to FIG. 8.

It should be noted that the method described herein describes one possible implementation, and that the operations and the steps may be rearranged or otherwise modified and that other implementations are possible.

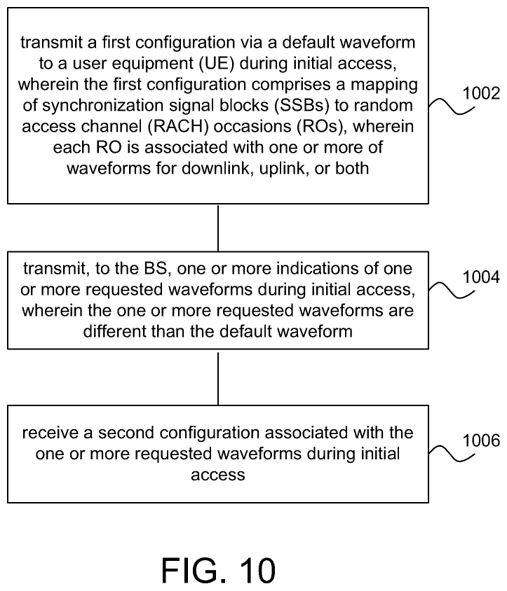

FIG. 10 illustrates a flowchart of a method performed by a UE 600 in accordance with aspects of the present disclosure. The operations of the method may be implemented by a UE 600 as described herein. In some implementations, the UE 600 may execute a set of instructions to control the function elements of the UE 600 to perform the described functions.

At step 1002, the method may receive a first configuration via a default waveform from a BS during initial access, wherein the first configuration comprises a mapping of SSBs to ROs, wherein each RO is associated with one or more of waveforms for downlink, uplink, or both. The operations of step 1002 may be performed in accordance with examples as described herein. In some implementations, aspects of the operations of step 1002 may be performed by a UE 600, as described with reference to FIG. 6.

At step 1004, the method may transmit, to the BS, one or more indications of one or more requested waveforms during initial access, wherein the one or more requested waveforms are different than the default waveform. The operations of step 1004 may be performed in accordance with examples as described herein. In some implementations, aspects of the operations of step 1004 may be performed by a UE 600, as described with reference to FIG. 6.

At step 1006, the method may receive a second configuration associated with the one or more requested waveforms during initial access. The operations of step 1006 may be performed in accordance with examples as described herein. In some implementations, aspects of the operations of step 1006 may be performed by a UE 600, as described with reference to FIG. 6.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
transmit a first configuration via a default waveform to a user equipment (UE) during initial access, wherein the first configuration comprises a mapping of synchronization signal blocks (SSBs) to random access channel (RACH) occasions (ROs), wherein each RO is associated with one or more of waveforms for downlink, uplink, or both;
receive, from the UE, one or more indications of one or more requested waveforms during initial access, wherein the one or more requested waveforms are different than the default waveform; and
transmit a second configuration associated with the one or more requested waveforms during initial access.

2. The NE of claim 1, wherein the at least one processor is configured to cause the NE to:
transmit a system information block one (SIB1),
wherein the first configuration is transmitted via the SIB1.

3. The NE of claim 1, wherein the at least one processor is configured to cause the NE to:
receive one or more first random access transmissions from the UE during one or more ROs associated with one or more SSBs, wherein the one or more first random access transmissions is associated with the default waveform, and wherein the one or more indications of one more requested waveforms is received via the one or more first random access transmissions; and
transmit one or more second random access transmissions to the UE based at least in part on the received one or more first random access transmissions, and wherein the second configuration is transmitted via the one or more second random access transmissions.

4. The NE of claim 3, wherein, to receive one or more first random access transmissions, the at least one processor is configured to cause the NE to:
receive a first physical random access channel (PRACH) transmission from the UE during at least one RO, wherein the first PRACH transmission is indicative of at least one waveform for uplink; and
receive a second PRACH transmission from the UE during at least one RO, wherein the second PRACH transmission is indicative of at least one waveform for downlink.

5. The NE of claim 4, wherein one or more of the first PRACH transmission and the second PRACH transmission are received via the default waveform or at least one waveform of the one or more requested waveforms.

6. The NE of claim 4, wherein one or more of the first PRACH transmission and the second PRACH transmission are received during a same RO or different ROs.

7. The NE of claim 4, wherein the second configuration comprises information for each of the at least one waveform for uplink and the at least one waveform for downlink for one or more subsequent random access transmissions associated with the initial access.

8. The NE of claim 3, wherein:
the one or more second random access transmissions are transmitted via the default waveform in response to a rejection of the one or more requested waveforms by the NE for initial access, or
the one or more second random access transmissions are transmitted via the one or more requested waveforms in response to an acceptance of the one or more requested waveforms by the NE for initial access.

9. The NE of claim 1, wherein, to receive one or more first random access transmissions, the at least one processor is configured to cause the NE to:
receive a random access transmission during initial access and based at least in part on the second configuration, wherein the random access transmission comprises a random access message 3 (Msg3), and wherein the random access transmission is associated with at least one waveform for uplink associated with the one or more requested waveforms; and
transmit a random access transmission during initial access and based at least in part on the second configuration, wherein the random access transmission comprises a random access message 4 (Msg4), and wherein the random access transmission is associated with at least one waveform for downlink associated with the one or more requested waveforms.

10. The NE of claim 1, wherein each SSB is associated with multiple ROs, and wherein each RO of the multiple ROs is associated with one or more of a respective downlink waveform or a respective uplink waveform.

11. The NE of claim 1, wherein each of one or more of the default waveform, the downlink waveform, or the uplink waveform comprises a Cyclic Prefix Orthogonal Frequency Multiplexing (CP-OFDM) waveform or a Discrete Fourier Transform Spread OFDM (DFT-s-OFDM) waveform.

12. The NE of claim 1, wherein the one or more indications is implicitly received based on one or more selected ROs associated with the one or more requested waveforms.

13. A method performed by a network equipment (NE), the method comprising:
transmitting a first configuration via a default waveform to a user equipment (UE) during initial access, wherein the first configuration comprises a mapping of synchronization signal blocks (SSBs) to random access channel (RACH) occasions (ROs), wherein each RO is associated with one or more of waveforms for downlink, uplink, or both;
receiving, from the UE, one or more indications of one or more requested waveforms during initial access, wherein the one or more requested waveforms are different than the default waveform; and
transmitting a second configuration associated with the one or more requested waveforms during initial access.

14. A user equipment (UE) for wireless communication, comprising:
at least one memory; and
at least one processor coupled with the at least one memory and configured to cause the UE to:
receive a first configuration via a default waveform from a base station (BS) during initial access, wherein the first configuration comprises a mapping of synchronization signal blocks (SSBs) to random access channel (RACH) occasions (ROs), wherein each RO is associated with one or more of waveforms for downlink, uplink, or both;
transmit, to the BS, one or more indications of one or more requested waveforms during initial access, wherein the one or more requested waveforms are different than the default waveform; and
receive a second configuration associated with the one or more requested waveforms during initial access.

15. The UE of claim 14, wherein the at least one processor is configured to cause the UE to:
receive a system information block one (SIB1),
wherein the first configuration is transmitted via the SIB1.

16. The UE of claim 14, wherein the at least one processor is configured to cause the UE to:
transmit one or more first random access transmissions to the BS during one or more ROs associated with one or more SSBs, wherein the one or more first random access transmissions is associated with the default waveform, and wherein the one or more indications of one more requested waveforms is received via the one or more first random access transmissions; and
receive one or more second random access transmissions from the BS based at least in part on the transmitted one or more first random access transmissions, and wherein the second configuration is transmitted via the one or more second random access transmissions.

17. The UE of claim 16, wherein, to transmit one or more first random access transmissions, the at least one processor is configured to cause the UE to:
transmit a first physical random access channel (PRACH) transmission to the BS during at least one RO, wherein the first PRACH transmission is indicative of at least one waveform for uplink; and
transmit a second PRACH transmission to the BS during at least one RO, wherein the second PRACH transmission is indicative of at least one waveform for downlink.

18. A method performed by a user equipment (UE), the method comprising:
receiving a first configuration via a default waveform from a base station (BS) during initial access, wherein the first configuration comprises a mapping of synchronization signal blocks (SSBs) to random access channel (RACH) occasions (ROs), wherein each RO is associated with one or more of waveforms for downlink, uplink, or both;
transmitting, to the BS, one or more indications of one or more requested waveforms during initial access, wherein the one or more requested waveforms are different than the default waveform; and
receiving a second configuration associated with the one or more requested waveforms during initial access.

19. The method of claim 18, further comprising:
receiving a system information block one (SIB1),
wherein the first configuration is transmitted via the SIB1.

20. The method of claim 18, further comprising:
transmitting one or more first random access transmissions to the BS during one or more ROs associated with one or more SSBs, wherein the one or more first random access transmissions is associated with the default waveform, and wherein the one or more indications of one more requested waveforms is received via the one or more first random access transmissions; and
receiving one or more second random access transmissions from the BS based at least in part on the transmitted one or more first random access transmissions, and wherein the second configuration is transmitted via the one or more second random access transmissions.
